(19) United States
(12) Patent Application Publication
(10) Pub. No.: US 2010/0269349 A1
(43) Pub. Date: Oct. 28, 2010

(54) ELECTRICALLY OPERATED SHAVING APPLIANCE

(76) Inventor: Andreas Erndt, Kelkheim (DE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/678,293

(22) PCT Filed: Sep. 10, 2008
(86) PCT No.: PCT/EP08/07387

§ 371 Date: Jun. 15, 2010

(30) Foreign Application Priority Data
Oct. 19, 2007 (DE) 10 2007 050 057.4

(51) Int. Cl. B26B 19/28

(52) U.S. Cl. 30/42

(57) ABSTRACT

The invention relates to an electrically operated shaving appliance (25) comprising a drive element (4) that can be driven by an electric motor in a back-and-forth movement and drives at least one cutting system (28, 32), the shaver housing (1) thereof being displaceable into a pulled-out or inserted position by means of a guiding arrangement (29) that can also be moved in relation to the shaver housing (1). Part of the movement of the drive element (4) is deviated by a deviation device (2) in the direction (X, Y) of displacement. According to the invention, the deviation device (2) consists of at least one wall (12, 19) extending in the direction (X; Y) of displacement thereof and at least one elastic element (5, 6) connected to the drive element (4) in a fixed manner, said elastic element (5, 6) coming into contact with the wall (12, 19) after the displacement of the shaver housing (1) out of its starting or end position, and is then bent between the drive element (4) and the wall (12, 19) in the direction (X or Y) of displacement. Means (14, 16) are provided at the contact point (39) between the elastic element (5, 6) and the wall (12, 19), said means partially deviating the displacement path (b or c) of the drive element (4), created during the advancing movement (Z), from the elastic element (5, 6) towards the shaver housing (1), thereby causing the housing to move in the direction (X or Y) of displacement. During the return movement, the elastic element (5 or 6) is only in sliding contact with the associated wall (12, 19). The invention enables an especially simple electromotively driven forwards and backwards movement of a cutting device.

The present invention relates to an electrically operated shaving apparatus according to the preamble of Claim 1.

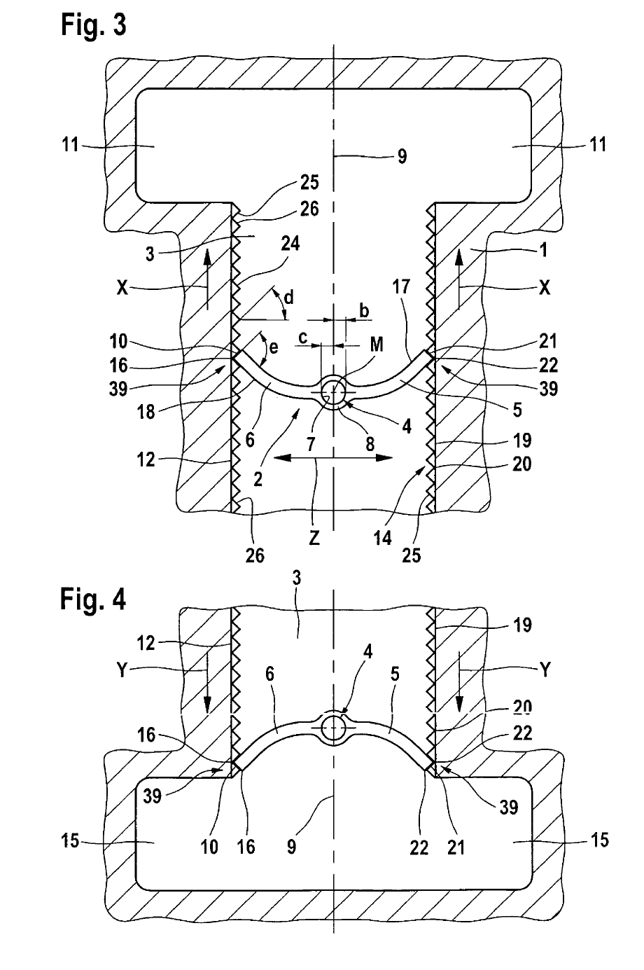

From DE 195 31 013 C1, a shaving apparatus indicated is already known according to the preamble of Claim 1. According to FIG. 3, here both a first and a second cutting system are designed on the upper side of the shaving apparatus. The first cutting system is made up of two perforated foils arranged next to one another, which typically designated as the upper blade, and two lower blades arranged thereunder, in sliding contact therewith. This first cutting system is designated as a so-called short-hair cutting system K1, K2. A medium-hair cutter L2 is designed between these two short-hair cutters which is intended for cutting somewhat longer hairs to an extent such that the remaining hair stubs can be better engaged by the short-hair cutters.

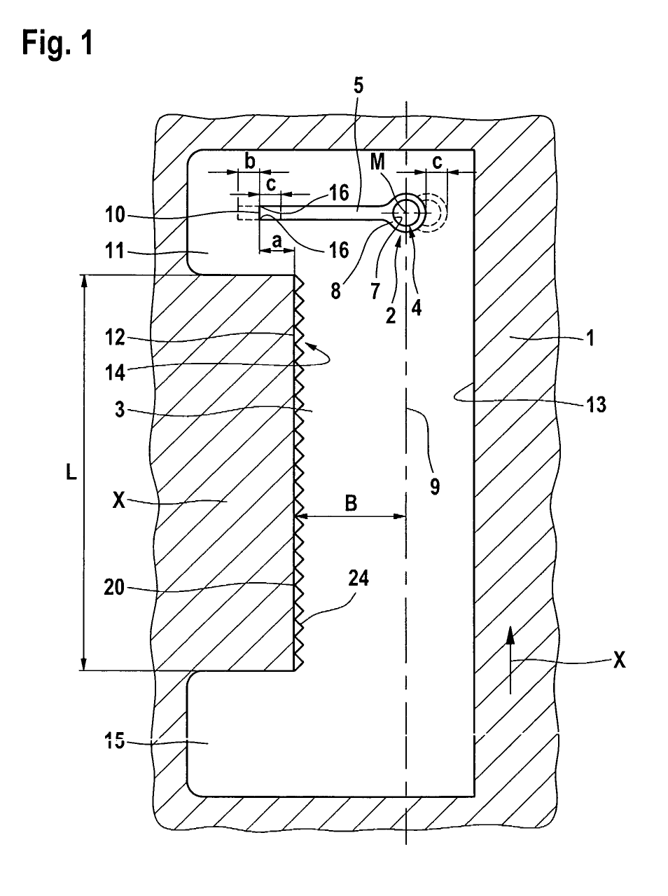

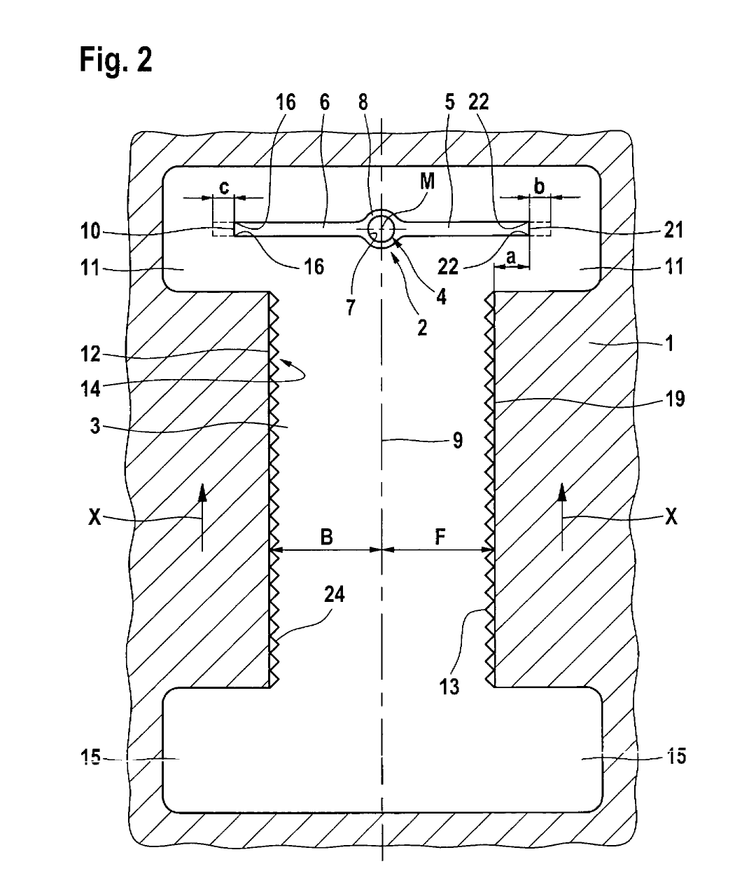

On the front side according to FIG. 1, a long-hair cutter L1, arranged on a shaver housing, is displaceable lengthwise in its height, that is used in its extended upper position shown in FIG. 2, in particular for cutting contours or trimming hair. The long-hair cutter L1 has an upper blade 17 on its upper end and has a lower blade 18 thereunder that slides along upper blade 17 and that can be driven in oscillatory fashion by an electric motor via a mechanically switchable drive part.

In order to extend the long-hair cutter L1, the actuating button 9 is brought into a first position, wherein the electric motor 27 is set into rotation and drives a threaded spindle that in turn displaces the shaver housing 8, according to FIG. 2, from its retracted position into its extended position via a lantern pinion 31. When the long-hair cutter L1 is switched off, it is moved back into its initial position by the electromotorically driven displacement device. The electromotoric displacement device is relatively expensive to produce, which can result in a significant increase in the manufacturing costs of a shaving apparatus.

From DE 10 2004 029 234 A1, an electrically operated shaving apparatus of the type described above is known. In this shaving apparatus as well, the cutting system, operating as a long-hair cutter, is no longer retracted or extended into or out of the housing by hand, but rather by the drive device of the shaving apparatus. For this purpose, the drive part, which is connected to an electric motor and which oscillates back and forth, is connected to a deflection device that, according to FIG. 3, converts the horizontal direction of movement into a vertical direction of movement. As soon as the deflection device is actuated manually via an actuating switch, the shaver housing moves in the direction of displacement upward or downward. This movement runs transverse or perpendicular to the movement of the drive part. Here as well, the deflection device is made up of a relatively large number of components, which can result in significant manufacturing costs for a shaving apparatus.

The object of the invention is to create a shaving apparatus whose extendable or retractable cutting system is realized in a particularly simple manner and also requires a small number of components. In this way, an economical shaving apparatus is to be created.

According to the invention, this object is achieved by the features of Claim 1. According to the invention, an elastic element that is uncompressed in the initial or final position of the shaver housing is connected to the drive part that moves back and forth in a rotationally fixed and axially non-displaceable fashion, so that the distance of the free end of the elastic element to the center axis of the drive part is greater than the distance of the wall to the center axis of the drive part. When the shaver housing is displaced in order to extend or retract the long-hair cutter, the free end of the elastic element comes into contact with the beginning of the wall, and upon further displacement, the elastic element is bent in the direction of displacement so that the free end is fixed in the wall surface. In this process, it is, of course, necessary for the drive part to absorb the spring force that arises at the elastic element and not to escape in the opposite direction of displacement. For this purpose, for example, springs can engage on the drive part that produce a greater spring force than that resulting from the bending force. However, the oscillating drive forces must then be greater than these spring forces. In order to achieve, according to the invention, an automatic advance at the shaver housing, the ends of the elastic element that can be brought into contact with the wall, as well as the wall itself, must be designed such that during the movement of the drive part toward the wall, the free end of the elastic element is hooked in the wall, or forms a fixed engagement therewith, while during the movement back of the drive part past the center toward the other side, the connection between the free end of the elastic element and the wall is disconnected and transitions to a sliding process. The effect is similar to that of a ratchet locking mechanism, in which it is likewise the case that in the one direction something is carried along while in the other direction the driving part slides through without entraining anything. The realization of the invention is particularly simple because a strip-shaped element can be positively fastened to the drive part as an elastic element, or can even be integrally formed in one piece thereon.

The features of Claim 2 provide that an automatic switching off of the drive takes place both in the initial position and in the final position. Due to the expansion at the two ends of the walls in the direction of displacement, the elastic element can be deformed in its direct position, i.e. in a straight line, and there no longer has contact with the walls. The deflecting device is therefore detached from the shaver housing.

According to the features of Claim 3, the surface of the wall has recesses that are situated one after the other along its length, in which the free ends of the elastic element engage. The recesses can for example be formed by fine teeth whose wall surfaces form a thread angle with the axis running perpendicular to the direction of displacement, said angle is preferably between 30° and 60°. Here, the free end of the elastic element forms an obtuse angle with the side surfaces. The free end is therefore firmly supported on the individual teeth in the direction of displacement, while in the direction of detachment it slides away over the teeth. The wall can also have only a certain degree of surface texture, so that here a somewhat sharp-edged free end of the elastic element can also have a firm engagement in the direction of displacement but will merely slide along in the direction opposite the direction of displacement. The teeth run perpendicular to the direction of displacement of the shaver housing.

According to the features of Claim 4, the wall or walls, as well as the free end of the elastic element or elements can also be provided with a micro-toothing that also results in a sliding clutch manner of operation.

According to the features of Claim 5, the wall runs parallel to the direction of displacement of the shaver housing. In this way, the result is that the elastic element is always bent equally strongly during engagement in the wall, so that accordingly a predetermined bending tension, and thus a constant pressure force acting on the wall, is maintained. This is also supported by the features of Claim 6.

Through the features of Claim 7, the degree of bending and pre-tension of the elastic element is determined as a function of the selected cross-section. The pre-tension or bending force of the elastic element must be selected large enough that the pressure force, which increases at the elastic element during the outward movement of the drive part, is sufficient to displace the shaver housing in its guide by diverting the pressure force to form a displacement force.

According to the features of Claim 8, the elastic element is preferably made of metal. Here, a plate element is used that is preferably made of spring steel and that therefore has good elastic flexibility without losing its spring characteristic. According to the features of Claim 9, the elastic element can however also be made of plastic, as long as this material has particularly good spring characteristics.

According to the features of Claim 10, an elastic element extends on both sides of the drive part, and respective walls are arranged on both sides of the drive part, parallel to one another, so that when the elastic element engages in the two walls this element is bent essentially in a U-shape, and also runs essentially symmetrical to the center axis of the drive part. In this way, no bending forces are transmitted to the drive part, and when there is a back-and-forth movement of the drive part the double path can be executed at the displacement device. Here, a back-and-forth movement is to be understood as the path from the initial position of the drive part once to the one side and once to the other side. Thus, for example, during the outward movement of the drive part the right segment of the elastic element forms a non-positive connection with the wall, so that during the advance the shaver housing is displaced, while the left segment slides on the wall. In contrast, during the movement away of the drive part the right segment of the elastic element slides along on the wall, while the left segment forms a non-positive connection with the wall and displaces it. Thus, during a back-and-forth movement of the drive part the shaver housing is displaced twice.

The spring elements are preferably formed by a single shaped part that is fastened to the drive part in a rotationally fixed and axially non-displaceable manner Features relating to the realization on the one side according to Claims 1 through 9 are accordingly also to be transferred to the other side. For the sake of simplicity, therefore, the corresponding design and operation of the walls and of the elastic elements on the other side are not further discussed here.

In a further embodiment of Claim 10, the walls according to Claim 11 form a common slot in which the drive part runs, centrically in the slot. This embodiment creates an elastic element that is held symmetrically in the slot, whose forces are equally transmitted to the left and right to the walls. This results in a particularly homogenous displacement of the shaver housing out of or into the housing of the shaver.

According to the features of Claim 12, the invention can be realized for a shaving apparatus that has only a single cutting system designed on a shaver housing. Such a shaving apparatus is then designated as a purely short-hair or long-hair cutter. In this embodiment, it is then advantageous if the single cutting system can be protectively stored in a housing when it is not being used. During use, in contrast, the cutting system can then automatically be extended out of the shaver housing.

However, it is equally possible to arranged, on a short-hair cutter formed in stationary fashion on a shaver housing, preferably on its front side, a long-hair cutter that can be extended from or retracted into the shaver housing, which can then be provided with the deflection and actuation device according to the invention. However, the deflection and actuation device according to the invention can also be used in all personal hygiene devices in which devices that generally treat the hair or the skin are used, such as plucking or massage devices, which can be extended from or retracted into the housing for better accessibility or better protection.

An exemplary embodiment of the invention is shown in the drawing and is explained in further detail in the following.

FIG. 1 shows a graphic representation of a segment of a shaver housing, completely retracted into a shaver housing, in a greatly enlarged scale, in a longitudinal section according to the invention according to Claim 1,

FIG. 2 shows a graphic representation of a segment of a shaver housing, completely retracted into a shaver housing, in a greatly enlarged scale in longitudinal section, wherein, in contrast to FIG. 1, two elastic elements extend away from the drive part, each capable of being brought into contact with a respective wall,

FIG. 3 shows a cutout according to FIG. 2, wherein, however, the shaver housing has already been partly moved out of the shaver housing, from the initial position, by the deflecting device according to the invention,

FIG. 4 shows a cutout according to FIG. 2, wherein, however, for the retraction of the shaver housing this housing has been moved back from its extended upper final position far enough that the elastic elements are deformed and have already moved into engagement with the walls, so that during oscillating movement of the drive part the shaver housing is then moved back into its initial position, and

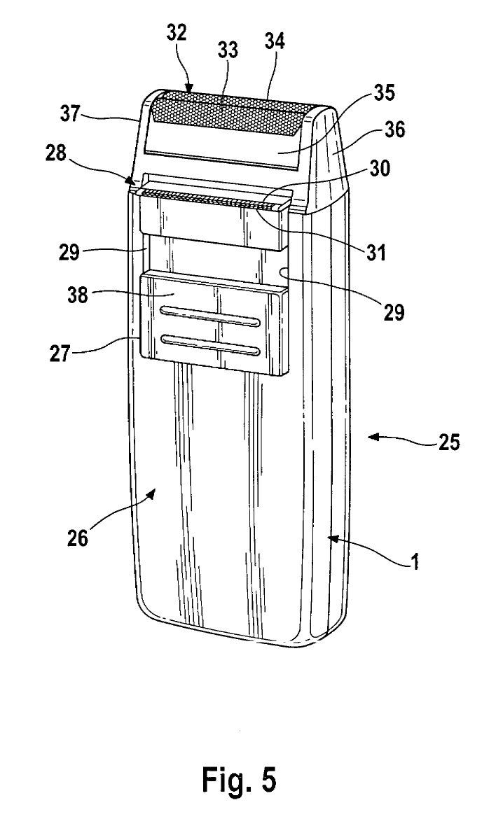

FIG. 5 shows a perspective side view from the front right of a shaving apparatus, in a reduced scale.

First, it is to be mentioned that FIGS. 1 through 4 show only a segment of a shaver housing 1 on which deflecting device 2 can act. The representations are sufficient for the clear representation of the invention. However, in order to better understand the connection of the present invention to a shaver housing of a shaving apparatus, FIG. 5 shows a shaving apparatus 25 that has, on its front side 26 of a shaver housing 1, a first cutting system 28 that can be brought into an extended or retracted position. The cutting system 28 is made up of a long-hair cutter having comb-type upper and lower blades 30, 31 that slide along one another and that run transverse to shaver housing 1 and that protrude forward from said housing, in order in this way to better reach the skin surface of the user. On the front side, a second cutting system 32 is arranged having two shaving foils 33, 34 situated next to one another and two lower blades (not shown) that correspond thereto and that oscillate back and forth.

The second shaving system 32 is arranged on a pivoting head 35 that is pivotable transverse to the shaver housing 1, said head is pivotably mounted on lateral arms 36, 37.

The first cutting system 28 is capable of displacement along the shaver housing 29 on sliding rails 29, in a recess 27 designed on the front side 26 of the shaver housing 1. A button 38 is used to displace the cutting system 28. The shaver housing 1 acts as the carrying part of the cutting systems 28, 32.

According to FIGS. 1 through 4, a drive part 4 engages in a slot 3 designed on the shaver housing 1, said drive part being connected to the drive (not shown) of an electric motor (not shown) via mechanical transmission means (not shown). In the reference named above, DE 10 2004 029 234 A1, the drive part 4 corresponds to position number 22 according to FIGS. 2 through 5. This drive part 4 is, in addition to a further drive part (not shown) that drives the second cutting device 32 on the electric shaving apparatus 25, likewise driven by one and the same electric motor (not shown), and is thus set into a back-and-forth motion that, according to FIGS. 1 through 4, runs horizontally, i.e. transverse to the shaver housing 1.

The deflection device 2 is essentially made up of an elastic element 5 that is essentially strip-shaped and that is provided at one end with a thickening 8 that functions as a hub. The thickening 8 is provided in its center with a bore 7 through which a pin-shaped drive part 4 passes. The strip-shaped elastic element 5 is preferably connected to the drive part 4 in rotationally fixed and axially non-displaceable fashion via a press-fit seating. This is done so that during the desired bending of the elastic element during the displacement of the shaver housing 1 it cannot rotate or tilt on the drive part 4.

In contrast to FIG. 1, a respective elastic element 5, 6 extends away from the two sides of the drive part 4 in FIGS. 2 through 4; together, these elastic elements preferably form a single component and are connected in one piece to one another via a central thickening 8 or hub. Here as well, the thickening 8 has a bore 7 in its center through which the pin-shaped drive part 4 passes. The bore 7 likewise preferably forms a press-fit seating with the outer diameter of the drive part 4, so that the elastic elements 5, 6 are connected to the drive part 4 in a rotationally fixed and axially non-displaceable fashion. The elastic element or elements 5, 6 are preferably made of a spring steel plate or of a very elastic bendable plastic having a good spring characteristic.

According to FIGS. 1 through 4, the outer surface of the drive part 4 can also preferably consists of a polygon in cross-section, preferably a rectangle (not shown), onto which the elastic element 5 or 5, 6, provided with a corresponding bore 7, is shrink-fitted in a rotationally fixed fashion. For the rotationally fixed and axial securing of the elastic element or elements 5, 6 on the drive part, for example, gluing, welding, screwing, or some other fastening method typically used in machine construction may also be used.

According to FIGS. 1 through 4, the perpendicular center line 9 runs precisely through midpoint M of drive part 4 in the initial position of the drive part 4, wherein the guide system (not shown) of the shaver housing runs parallel to the perpendicular center line 9. The line 9 also forms the longitudinal axis of a shaving apparatus as is represented in the above-named reference according to FIG. 1.

According to FIG. 1, the elastic element 5 runs essentially horizontally on a straight line, i.e. perpendicular to the center line 9, in the untensioned state. The elastic element 5, 6 assumes this position both in the retracted and in the extended position of the shaver housing 1. In this position, its free end 10 extends into an open space 11 that expands laterally, i.e. to the right, relative to the slot 3. At a distance a from the free end 10, a wall 12 that runs parallel to center line 9 extends above the elastic element 5. In the initial position according to FIG. 1, the free end 10 of the elastic element 5 has no physical contact with the surface of the wall 12. The wall 12 runs parallel to the center line 9 over the length L. The dimension of the length L of the wall 12 corresponds to the path from the initial position to the end position of the cutting system; i.e., it is the path along which the shaver housing 1 moves out of or into the shaver housing (not shown).

According to FIG. 1, the slot 3 ends on the left side beyond center line 9 on a front surface or wall 13 that runs essentially parallel to the center line 9, but that however may also run along any other course, or that in general does not need to be present. The distance of the wall 13 from the outer surface of the thickening 8 must be dimensioned large enough that during the oscillating movement of the drive part 4, the thickening 8 can move without hindrance into the slot 3 without coming into contact with the front surface 13.

According to FIG. 1, the wall 12 is provided with a fine toothing 14 or else with a surface texture that is suitable to ensure, during the displacement of the shaver housing 1, an entrainment along with the elastic element 5 in the one direction and releasing in the other direction on the shaver housing 1; however, this is explained in more detail below on the basis of FIGS. 2 through 4. A further open space 15 that corresponds essentially to the open space 11 is arranged on the lower end of the wall 12. In addition, in FIG. 1 dimensions b and c are indicated. Dimension b indicates the stroke that the free end 10 makes to the right (shown in a broken line), while dimension c indicates the stroke in the opposite direction. Therefore, the dimension c plus b represents the overall deflection of the drive part 4, or of the free end 10 of the elastic element 5.

Differing from FIG. 1, a symmetrically arranged deflection device is shown in FIGS. 2 through 4, so that that which is shown to the left of the center line 9 in FIG. 1 is also present to the right of this center line 9 in FIGS. 2 through 4, whereby resulting in a symmetrical arrangement. Therefore, in order to avoid repetition, the right segment is not described again, because it corresponds identically to the left segment according to FIG. 1. For simplification, identical position numbers are used for identical components and designations in FIGS. 2 through 4.

The manner of operation of the arrangement according to the invention is now described only on the basis of FIGS. 2 through 4, because the functioning can also be carried over to FIG. 1, however, only for the one elastic element 5. If, according to FIGS. 2 through 4, the shaver housing 1, and thus the cutting system connected to shaver housing 1, which here is preferably a long-hair cutter (not shown), is extended upward out of the shaver housing (not shown), the shaver housing 1 is first displaced slightly in the direction X by hand in its guide system (not shown). Because the drive part 4 is mounted in the shaver housing so as to be capable of stationary oscillation in the direction of displacement X, the elastic elements 5, 6 move into the slot 3, and are now clamped between the walls 12, 19 in such a way that they bend upward elastically in a manner corresponding to FIG. 3. (According to FIG. 1, here only the one elastic element 5 bends.) In this process, corners 16, 22 designed on the free end 10, 21 hook into the profile-type surfaces of the walls 12, and form contact points 39.

The surfaces of the walls 12, 19 can be equipped with a fine toothing 14, wherein the individual teeth then have an angle d that is preferably between 30° and 60°. The front surface on the free end 10, 21 of the elastic elements 5, 6 forms with the upper and lower sides 17, 18 according to FIG. 3 an angle e that is preferably 90°. Thus, as soon as the corners 16, 22 come to lie on the upper first tooth flanks 25, the shaver housing 1 is moved upward in direction X by back-and-forth movement Z of the drive part 4 with each stroke b or c. (According to FIG. 1, the shaver housing 1 is moved upward in direction X only during stroke b, while during stroke c no displacement of the shaver housing 1 takes place.)

The bending rigidity of the elastic elements 5, 6 must be large enough that during the displacement of the drive part 4 to the left or to the right, a part of this path is deflected in the direction X, while a small part still goes into bending deformation at the elastic element 5 or 6. In the return stroke of the drive part 4 toward the other side, the free end 16 can then slide downward over a part of the toothing 14, and can engage in a tooth flank 25 arranged thereunder, while the opposite side corner 22 laying against the tooth flank 25 displaces the shaver housing 1 upward in direction X and then slides over the individual teeth 24 during the return stroke. Thus, during the back-and-forth movement in direction Z, the shaver housing 1 is displaced upward step-by-step in direction X in the guide system, until it has reached its maximally extended position (not shown). In this position, the elastic elements 5, 6 move into the open spaces 15, causing them to stretch elastically and to assume their initial shape as shown in the retracted position according to FIG. 2. The drive part 4 can continue to move back and forth in oscillating fashion without thereby influencing the displacement of the shaver housing 1, because the free ends 10 are not in engagement with the walls 12.

If the shaver housing 1 is now to be moved from its extended position back into its initial position, according to FIG. 4, the shaver housing is displaced slightly in direction Y by hand until the spring elements 5, 6 move into the slot 3 and are then bent downward elastically in direction Y. The corners 16, 22, designed on the free ends 10, 21 and arranged opposite the corners 16, 22, now hook into the tooth flanks 26 arranged opposite the tooth flanks 25. During the back-and-forth movement of the drive part 4, a part of the displacement path c or b is now deflected via the elastic elements 5, 6 onto the shaver housing 1, which is thus displaced in step-by-step fashion in the guide system (not shown) in direction Y. The elastic elements 5, 6 thus slightly move with each stroke of the shaver housing 1 in direction Y until they again reach the open spaces 11. The retracted position of the shaver housing 1 according to FIG. 2 is reached, and the elastic elements 5, 6 can again move elastically into their stretched shape. The tooth flanks 25, 26 form recesses 20 in which the corners 21, 22 engage.

The dimension a determines how strongly the elastic elements are elastically bent in the slot 3, and how large the movement at the shaver housing 1 is with each stroke. In order to achieve an optimal engagement of the elastic elements 5, 6 on the profile walls 12, the dimensions of the elastic elements are to be matched to the width of the slot 3 and to the profile surface on the walls 12.

What is claimed is:

1. An electrically operated shaving apparatus (25) for cutting hairs, having a drive part (4) that can be driven in a back-and-forth movement (Z) by an electric motor, having at least one cutting system (28, 32) and simultaneously displacing a cutting system (28) relative to the shaver housing via a deflection device (2), into an extended or retracted position, characterized in that the deflecting device (2) is made up of at least one elastic element (5, 6) that is fixedly connected to the drive part (4), and in that for the displacement of the cutting system (28) the elastic element (5, 6) is elastically bent and pre-tensioned in the direction of displacement between at least one wall (12, 19) that runs on the cutting system (28) and the drive part (4), and in that at the contact point (39) between the elastic element (5, 6) and the wall (12), means (14, 16) are fashioned by which the displacement path (b or e) that arises during the outward movement of the drive part (4) is partly deflected by the elastic element (5, 6) onto the shaver housing (1), and moves this housing in the direction of displacement (X or Y), while during the movement away of the drive part (4), the contact point (39) of the elastic element (5 or, respectively, 6) makes only sliding contact with the associated wall (12).

2. The shaving apparatus according to claim 1, characterized in that at the end of the wall (12, 19) an expansion (11, 15) is designed that corresponds to the initial position or the end position of the shaver housing (1).

3. The shaving apparatus according to claim 1, characterized in that the means are made up of a toothing (14) that runs on the surface of the wall (12, 19) over its length, into which the corners (16) designed on the free end (10, 21) of the elastic element (5, 6) engage.

4. The shaving apparatus according to claim 1, characterized in that the means are made up both of a micro-toothing designed on the surface of the wall (12, 19), and a micro-toothing designed on the free end (10, 21) of the elastic element (5, 6).

5. The shaving apparatus according to claim 1 or 2, characterized in that the wall (12, 19) runs parallel to the direction of displacement (X, Y) of the shaver housing (1).

6. The shaving apparatus according to claim 1 or 2, characterized in that the wall (12, 19) runs perpendicular to the back-and-forth movement (Z) of the drive part (4).

7. The shaving apparatus according to claim 1, characterized in that the elastic element (5, 6) is longer by the dimension a then is the dimension B or F from the center line (9) to the wall (12, 19).

8. The shaving apparatus according to claim 1, characterized in that the elastic element (5, 6) is a plate made of metal.

9. The shaving apparatus according to claim 1, characterized in that the elastic element (5, 6) is made of plastic.

10. The shaving apparatus according to claim 1, characterized in that an elastic element (5, 6) is fastened to the drive part (4) on both sides, and in that a respective wall (12, 19) is fashioned on each side of the shaver housing (1), and that the means are used on both sides.

11. The shaving apparatus according to claim 10, characterized in that the walls (12, 19) enclose a slot (3), and that the drive part (4) runs centrally to the slot (3).

12. The shaving apparatus according to claim 1, characterized in that the cutting system is a short-hair cutter and/or long-hair cutter that can be extended from the shaver housing or retracted into the shaver housing.
